(19) United States
(12) Patent Application Publication
(10) Pub. No.: US 2012/0210885 A1
(43) Pub. Date: Aug. 23, 2012

(54) FOOD INFUSER DEVICE, SYSTEM AND METHOD

(75) Inventors: NORMAN KAY, Sands Point, NY (US); Rachel SAMAROO, Cedarhurst, NY (US)

(73) Assignee: International Business Machines Corporation, Lake Success, NY (US)

(21) Appl. No.: 13/292,212

(22) Filed: Nov. 9, 2011

Related U.S. Application Data
(60) Provisional application No. 61/444,277, filed on Feb. 18, 2011.

(51) Int. Cl. A23L 1/48; B23P 19/00

(52) U.S. Cl. 99/494; 29/426.2

(57) ABSTRACT

A device and system for inserting at least a portion of a first edible material into an interior of a food product is provided. The device includes a body having a first end and a second end opposite the first end, the body having an axis, and a plunger associated with the body and adapted to move along the axis. The device also includes a spring adapted to urge the plunger along the axis toward the second end, and at least one hollow cylindrical head adapted to be removably mounted to the first end of the body. A first end of the plunger is adapted to move into an interior of the head mounted to the first end of the body when the plunger is moved against the urging of the spring toward the first end of the body. A method of changing heads of an apparatus is provided.

### CROSS-REFERENCE TO RELATED APPLICATIONS

This application claims the benefit of U.S. Provisional Application No. 61/444,277 filed Feb. 18, 2011, which is incorporated herein by reference.

### STATEMENT REGARDING FEDERALLY SPONSORED RESEARCH OR DEVELOPMENT

Not Applicable

### BACKGROUND OF THE INVENTION

1. Field of the Invention

The present invention relates to food infusers, and in particular relates to a food infuser having multiple, interchangeable and/or stackable heads that are able to inject olives, fruits and vegetables, or other food products with another fruit or vegetable, or another food product.

2. Description of the Related Art

Olives are often pitted and/or stuffed prior to eating. Olives may be stuffed with vegetables, cheese, or other appropriate foods.

A conventional olive infuser has one head that only allows the user to fill from the bottom. A conventional olive infuser may have a cleaning brush located inside the top of the plunger, which may be a wire brush with a rubber safety tip. A conventional olive infuser may be bulbous, chrome plated steel, and have a rubber handle. A conventional olive infuser may be composed of six parts: the head, body, spring, brush, plunger, and cap. A conventional olive infuser body may be one part, and the head may unscrew to reveal the spring and plunger.

### BRIEF SUMMARY OF THE INVENTION

The infuser provided herein (also referred to as an olive injector, or an olive infuser) enables a user to easily insert any of various types of food into an olive, fruit, vegetable, or any other appropriate food or material. The infuser provided includes multiple heads for various purposes, and includes a storage mechanism for unused heads, as well as cleaning implements. The ergonomic design allows easy and comfortable use.

A device for inserting at least a portion of a first edible material into an interior of a food product is provided. The device includes a body having a first end and a second end opposite the first end, the body having an axis, and a plunger associated with the body and adapted to move along the axis. The device also includes a spring adapted to urge the plunger along the axis toward the second end, and at least one hollow cylindrical head adapted to be removably mounted to the first end of the body. A first end of the plunger is adapted to move into an interior of the head mounted to the first end of the body when the plunger is moved against the urging of the spring toward the first end of the body.

In the device, a second end of the plunger may extend beyond the second end of the body under an influence of the spring, and the second end of the plunger may be adapted to be depressed to cause the plunger to move toward the first end of the body.

The device may include a cleaning brush adapted to removably mount inside the at least one hollow cylindrical head when the at least one hollow cylindrical head is mounted to the first end of the body.

The cleaning brush may be adapted to cap the at least one hollow cylindrical head, and/or the cleaning brush may be adapted to removably mount to the second end of the plunger.

The body may accommodate at least one head in an interior space accessible by an opening arranged on the body.

The device may include a second hollow cylindrical head, and the body may be adapted to accommodate at least two heads in the interior space arranged in a stacked configuration. The at least one head in the interior space may be arranged so that the plunger extends through another interior of the at least one head in the interior space.

The at least one hollow cylindrical head may include a grating head including internally sharp grater walls, and the grating head may be adapted to be loaded by inverting the device and pressing the first edible material in a grated form into the grating head.

The at least one hollow cylindrical head may include a scooping head including an indentation on a cutting end opposite an end of the scooping head attached to the body, and the indentation may be adapted to scoop material into the scooping head.

The at least one hollow cylindrical head may include a plunging head including a blade on a cutting end opposite an end of the plunging head attached to the body. The plunging head may include at least one axial gap extending from the cutting end in an axial direction and having a length less than a length of the head. The plunging head may include at least two axial gaps, and the at least two of the axial gaps may have different lengths.

The first and the second ends of the body may have larger cross-sectional areas perpendicular to the axis than a mid-section of the body between the first and the second ends.

A system for inserting at least a portion of a first material into an interior of a second material is provided. The system includes a body adapted to be grasped by a hand of a user and having a target end and a user end opposite the target end. The body has an axis extending from the target end to the user end. The system also includes a plunger coupled to the body and adapted to move along the axis, and a spring adapted to urge the plunger along the axis in a first direction toward the user end. The system further includes a set of interchangeable, hollow cylindrical heads. Each of the heads is adapted to removably attach to the body on the axis on the target end, and the plunger is adapted to move into an interior of one of the heads attached to the body when the plunger is moved against the spring in a second direction opposite the first direction.

The body may accommodate at least one head in an interior space accessible by an opening arranged on the body, and the at least one head in the interior space may be arranged so that the plunger extends through another interior of the at least one head in the interior space.

An end of the plunger extending out of the user end of the body may be adapted to be depressed to cause the plunger to move along the axis in the second direction.

The system may include a cleaning brush adapted to removably mount inside the head attached to the body when the head is attached to the body. The cleaning brush may be adapted to cap the head when the head is attached to the body, and the cleaning brush may be adapted to removably attach to the end of the plunger.

The set of interchangeable heads may include a grating head having internally sharp grater walls. The grating head may be adapted to be loaded by inverting the system and pressing the first material in a grated form into the grating head. The set of interchangeable heads may include a scooping head having an indentation on a lower rim opposite the end attached to the body. The indentation may be adapted to assist a user in scooping material into the scooping head. The set of interchangeable heads may include a plunging head having a blade arranged on a lower rim opposite the end attached to the body. The plunging head may include at least two axial gaps extending from the lower rim in an axial direction and having a length less than a length of the head.

A method of changing heads of an apparatus for inserting at least a portion of a first edible material into an interior of a food product is provided. The apparatus has a body having a first end and a second end opposite the first end, and has an interior space adapted to accommodate at least one cutting head. The apparatus has a plunger mounted on the second end of the body and adapted to move along an axis of the body, and has a spring adapted to urge the plunger along the axis toward the second end of the body. A first end of the plunger is adapted to move into a first interior of a first cutting head mounted to the first end of the body when the plunger is moved against the urging of the spring toward the first end of the body. The plunger extends through a second interior of the at least one cutting head accommodated in the interior space of the body. The method includes removing at least one cutting head from the interior of the body, and closing the body. The method also includes attaching the at least one cutting head to the first end of the body.

These objects and the details of the invention will be apparent from the following description and accompanying drawings.

### BRIEF DESCRIPTION OF THE DRAWINGS

FIG. 1 is a front elevation view of an exemplary embodiment of an infuser;

FIG. 2 is a perspective view of the exemplary embodiment of the infuser;

FIG. 3A is an elevation view of the exemplary embodiment of the infuser having a sectional line;

FIG. 3B is a cross-sectional view of the exemplary embodiment of the infuser cut along the sectional line of FIG. 3A;

FIG. 4A is a perspective view of exemplary stacked cutting heads of an exemplary embodiment of the infuser;

FIG. 4B is an elevation view of the exemplary stacked cutting heads having a sectional line;

FIG. 4C is a cross-sectional view of the exemplary stacked cutting heads cut along the sectional line of FIG. 4B;

FIG. 5A is an elevation view of a scooping head of an exemplary embodiment of the infuser;

FIG. 5B is a perspective view of the scooping head shown in FIG. 5A;

FIG. 6A is an elevation view of a plunging head of an exemplary embodiment of the infuser;

FIG. 6B is a perspective view of the plunging head shown in FIG. 6A;

FIG. 7A is an elevation view of a grating head of an exemplary embodiment of the infuser;

FIG. 7B is a perspective view of the grating head shown in FIG. 7A;

FIG. 8A is a perspective view of a brush of an exemplary embodiment of the infuser;

FIG. 8B is a side schematic view of a brush and cutting head of an exemplary embodiment of the infuser; and

FIG. 9 illustrates a method according to an exemplary embodiment in a flow chart.

### DETAILED DESCRIPTION OF THE INVENTION

The exemplary infuser may allow the user to easily fill an olive, fruit, vegetable or other food product with his or her desired filling in a fun and creative experience. The exemplary infuser may be composed of eight parts: the top of the body with silicon grip, the bottom of the body with silicon grip, plunger, three heads, spring, and brush/cap. The exemplary infuser may be spring-loaded, and a stiff spring, constructed of thick gauge wire, may be used to ensure that the spring is strong enough to handle regular usage.

An exemplary embodiment of an infuser according to the instant invention may include interchangeable heads, for example three interchangeable heads. An exemplary embodiment of an infuser may have two or more interchangeable heads. Two of the exemplary infuser heads may fill from the top, and one exemplary infuser head may fill from the bottom. The bottom head may have four slots to allow ease of filling. With the added slots, it may be easier to cut through harder cheeses and fruit. The blades may be internal and medium in size. In this manner, the user is able to modify the exemplary infuser using the head that is most appropriate for the intended filling.

Each head may be different and may be used to plunge or inject different material and/or for use plunging or injecting material into different olives, fruits, vegetables or other foods. A user can change the heads depending on what filling is being used by unscrewing the head that is in the active position and screwing the desired head into the active position. It may be possible to load more than one olive at a time, and/or load a head with enough injecting material to load more than one olive, fruit, vegetable or other food without refilling the head of the exemplary infuser.

One or more heads may be able to be loaded from the bottom. In the scenario of filling with pine nuts and using the scooping head, the user may scoop the nuts into the head, turn the unit over or sideways to prevent the nuts from falling out, insert the hole of the olive into the head, and then plunge the contents into the olive.

The head may also be bottom loaded. The bottom of the head may be smooth. A user may turn the head upside down when assembled onto the body of the exemplary infuser and load the head from the bottom with fruit, zest, or garlic (for example). A user may then lower the hole of the olive (or other food product) onto the head of the infuser, and subsequently turn the infuser and olive over and the plunge contents of the head into the olive hole.

In the exemplary infuser having a total of three heads, the two of the exemplary infuser heads not in use may be stored inside the body of the infuser. The interchangeable heads may be nested and/or stacked within or on each other. The top ⅜ of an inch of heads may be threaded with durable threads. The ⅜ of an inch area below the threads may be for gripping the head to unscrew or re-screw the head from the body. When the interchangeable heads are not in use, they may be stored inside the plunger body. The heads may be fabricated out of metal, plastic or any other appropriate material. A brush may be used as a cap for the heads. The brush may slide onto the plunger, or alternatively the brush may slide onto any one of the heads.

The exemplary infuser body may have different designs, and may be composed of acrylic, aluminum, and/or stainless steel. The exemplary infuser may be composed of FDA approved stainless steel. The body of the unit, including the top part and the bottom part, may be fabricated from brushed stainless steel. Alternatively, the body of the unit may be formed from one part. The plunger and heads may be fabricated from stainless steel. The body sleeves and brush handle may be fabricated from silicone. The infuser body may be composed of two parts, a top housing the spring, and a bottom storing the interchangeable heads. A spring, which may be stainless steel, may be welded onto a plunger plate. The top and bottom of the body may be threaded and tapped to receive each other. In particular, the bottom of the body may be tapped and the three interchangeable heads may also be threaded. The plunger itself may be removable and may become a cleaning handle.

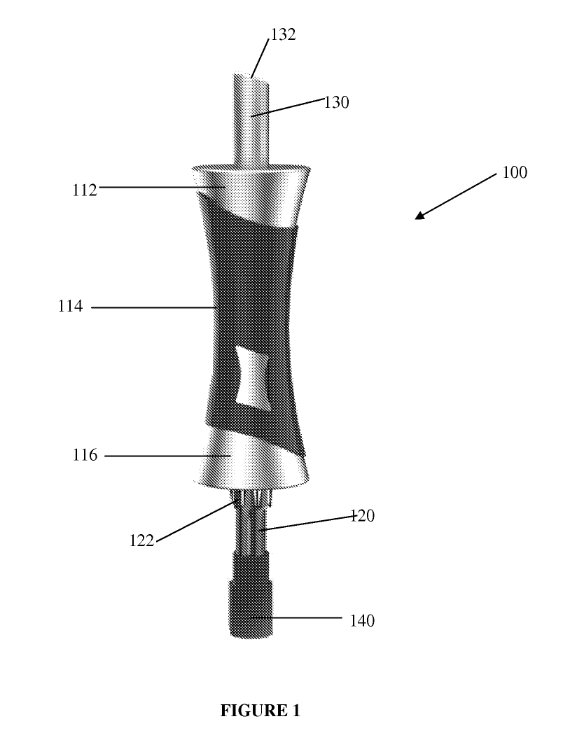

FIG. 1 is a front elevation view of an exemplary embodiment of infuser 100. Exemplary infuser 100 may include body 110, head 120, plunger 130, and brush 140. Body 110 may include plunger end 112, mid-section 114, and head end 116. Body 110 may be made of brushed stainless steel, or any other appropriate material, and may be sheathed in silicone or plastic along all or part of an exterior, and may in particular be sheathed only around mid-section 114. Body 110 may have cylindrical cross-sections, and cross-sections of plunger end 112 and head end 116 may be approximately equal in size, and may be larger than a cross-sectional area of mid-section 114.

Plunger 130 may include actuation tip 132, which may be a canted surface to facilitate actuation by a thumb of a user grasping body 110. Head 120 may include gripping section 122 near and head end 116 for holding head 120 when unthreading head 120 from body 110. Brush 140 may be inserted into an end of head 120 and may form a friction fit with head 120 to secure brush 140 in position.

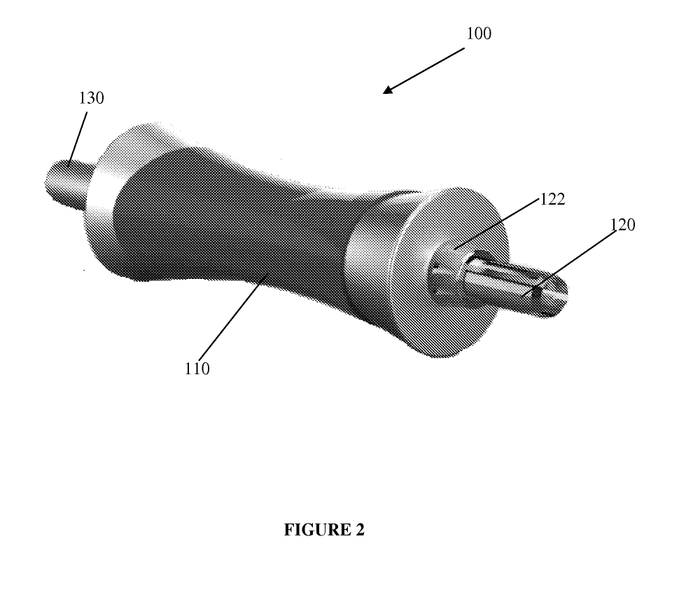

FIG. 2 is a perspective view of the exemplary embodiment of infuser 100. Shown in FIG. 2 are body 110, head 120, and plunger 130. A brush is not present in head 120 in FIG. 2, and therefore infuser 100 of FIG. 2 is ready to be used to insert edible material into a food product. Gripping section 122 of head 120 is shown in FIG. 2.

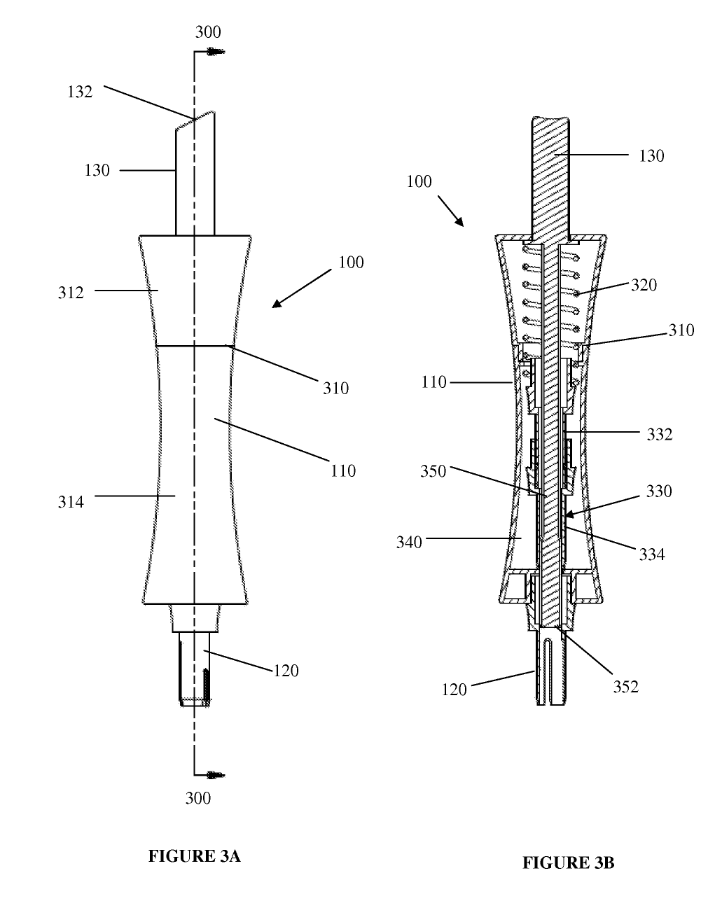

FIG. 3A is an elevation view of the exemplary embodiment of infuser 100 having sectional line 300. Infuser 100 of FIG. 3 includes body 110, head 120, and plunger 130. Body 110 of infuser 100 of FIG. 3 is composed of two parts connected at attachment point 310. Top body part 312 and bottom body part 314 connect to each other at attachment point 310, and may connect using threads, a snap lock mechanism, or any other appropriate reversibly attachable mechanism.

FIG. 3B is a cross-sectional view of the exemplary embodiment of infuser 100 cut along sectional line 300 of FIG. 3A. Body 110 is composed of two parts connected at attachment point 310, and defines interior space 340. In interior space 340 of body 110 is spring 320, which is coupled to plunger 130 and is biased to urge plunger 130 into an unactuated position. Also arranged in interior space 340 of body 110 are stacked heads 330, which in the exemplary embodiment shown in FIG. 3B includes two stacked heads 332, 334. As shown in FIG. 3B, plunger 130 includes shaft 350 extending through interior space 340 to head 120. Actuating infuser 100 by pressing actuation tip 132 causing plunger 130 to move with respect to body 110, thereby compressing spring 320, causes shaft 350 to move into the interior of head 120. Shaft 350 includes activation surface 352 which injects any food item therein into any other food item that head 120 has been previously inserted into when shaft 350 moves into the interior of head 120.

Stacked heads 332, 334 may fit snugly or in a snap-lock position within interior 340 of body 110. Shaft 350 extends through the interior of stacked heads 332, 334 and may be activated without significant interference from stacked heads 332, 334.

In alternative embodiments, the stacked heads stored in interior space 340 of body 110 may be one head or more than two heads. In still further alternatives, the shaft of plunger 130 may contact the stored stacked heads which may also contact a distinct and separate activation surface so that the stacked heads become an element in the plunging system. In still further alternatives, an arrangement for preventing removal of spring 320 and plunger 130 may be provided, and body 110 may not have an interior space and one head may be removably mounted on body 110. The arrangement for preventing removal of spring 320 and plunger 130 may include some or all of body 110 fixedly enclosing spring 320 and plunger 130.

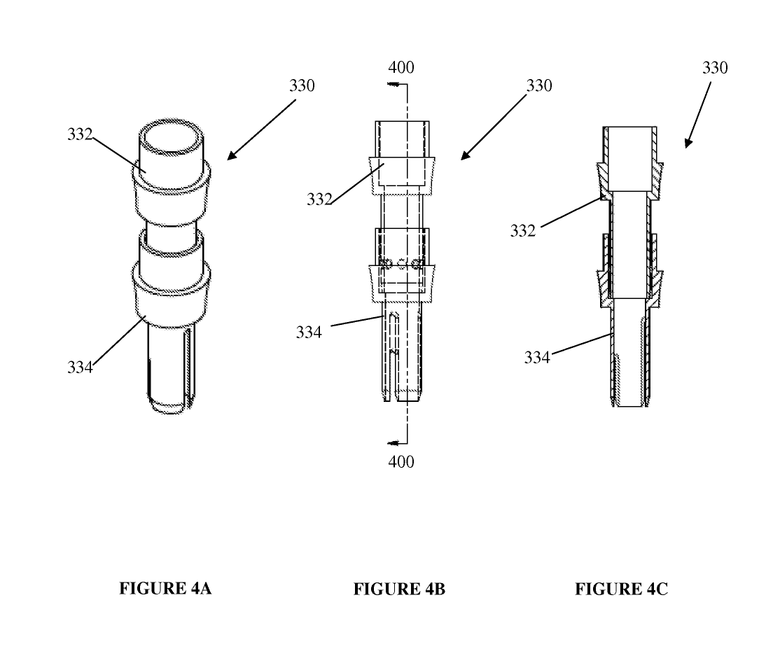

FIG. 4A is a perspective view of exemplary stacked cutting heads 330 of an exemplary embodiment of the infuser. Stacked cutting heads 330 includes two cutting heads 332, 334.

FIG. 4B is an elevation view of the exemplary stacked cutting heads 330 having sectional line 400. Stacked cutting heads 330 includes two cutting heads 332, 334.

FIG. 4C is a cross-sectional view of the exemplary stacked cutting heads 330 cut along sectional line 400 of FIG. 4B. Stacked cutting heads 330 includes two cutting heads 332, 334. Cutting heads 332, 334 are shaped to stack with a snug or friction fit so that the axes of each of cutting heads 332, 334 are aligned. In this manner, the interior space of stacked cutting heads 330 remains open to allow the passage of the shaft of a plunger for purposes of inserting edible food material into other food items.

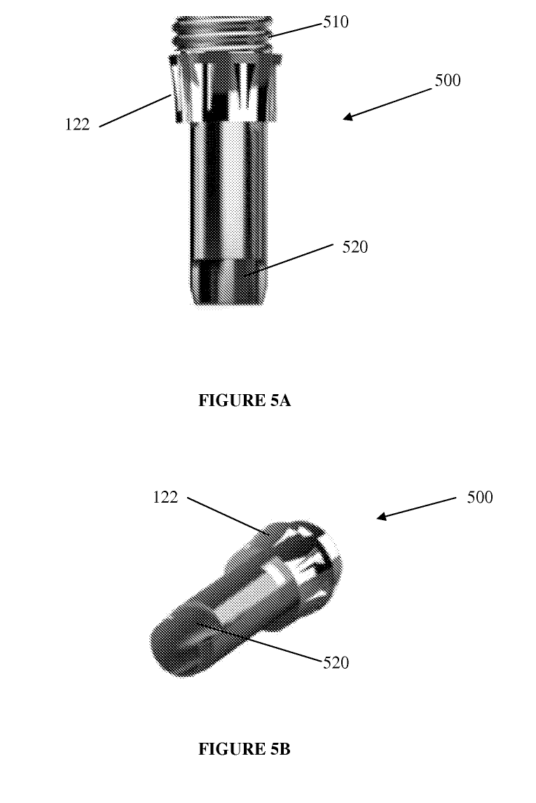

FIG. 5A is an elevation view of scooping head 500 of an exemplary embodiment of the infuser. Scooping head 500 includes threads 510 for attachment to the body of an infuser, and gripping section 122 for grasping scooping head 500 when attaching or detaching it from the body of an infuser. Scooping head 500 also includes scoop 520 on an end opposite threads 510. Scoop 520 is for scooping edible food material into an interior space of scooping head 520. Scooping head 500 may have smooth internal and bottom edges, which may be safe to touch. Scoop 520 may include an opening to enable the edible food material (also referred to herein as filling) to be easily loaded into scooping head 500. Scooping head 500 may be used to scoop crushed or small nuts, or chopped peppers, and inject them into an olive, vegetable or fruit. Scoop 520 is designed for easily shoveling fillings into the scooping head. The user can use their fingers to assist this process.

FIG. 5B is a perspective view of scooping head 500 shown in FIG. 5A. Scooping head 500 includes gripping section 122 and scoop 520 on an end opposite gripping section 122. The bottom of scooping head 500 and inside edge may be smooth, and may be loaded from the bottom for ease of use. Scooping head 500 may be used for nuts and cut fruit or vegetables, among other things. Scoop 520 may not be adapted to be plunged into cheese or fruit, but rather instead for scooping small nuts or crushed larger nuts. After loading scooping head 500 from the bottom, scooping head 500 may be inserted into the hole of an olive or other food product. Thereafter, the infuser may be turned over so that scooping head 500 is directed downward and the actuation tip of the plunger faces upward, and the contents of scooping head 500 may be plunged into the olive hole.

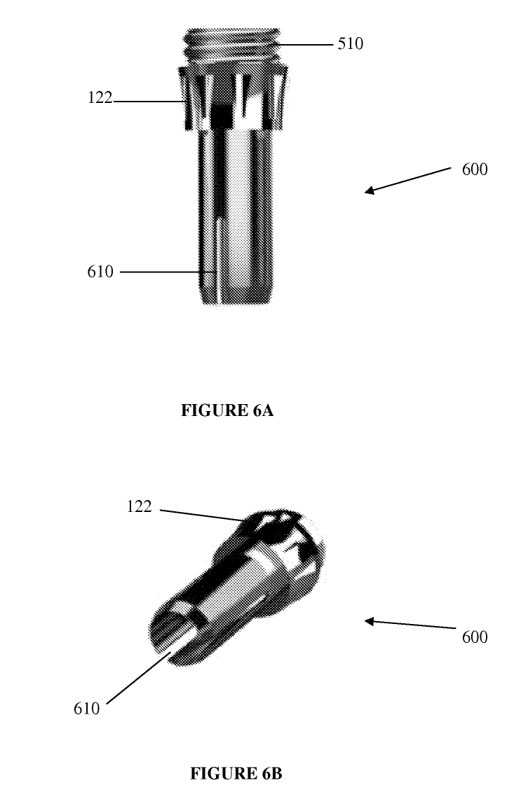

FIG. 6A is an elevation view of plunging head 600 of an exemplary embodiment of the infuser. Plunging head 600 includes threads 510 for attachment to the body of an infuser, and gripping section 122 for grasping plunging head 600 when attaching or detaching it from the body of an infuser. Plunging head 600 also includes axial gap 610 (also referred to herein as a groove or slot) on an end opposite threads 510. The exemplary plunging head may have one groove, two grooves, three grooves, four grooves, or more than four grooves. Three slots on the body of the head may ensure that the plunging experience is easy. The grooves may be strategically placed to ensure that it is easy to plunge into the material that the consumer wishes to fill the head with, and the number of grooves may be limited to ensure that the material does not become too weak. The grooves may be different lengths. In an exemplary plunging head 600 having three grooves, two of the grooves may have a length of ⅞ of an inch and the other groove may have a length of ½ of an inch.

Plunging head 600 may have sharp edges, and in particular the bottom edges may be sharp and chamfered. Plunging head 600 may not be designed for the user to directly touch the edges. Plunging head 600 may be loaded by plunging plunging head 600 into the desired filling. The top of plunging head 600 may be threaded for easy assembly to the body of the exemplary infuser. Plunging head 600 may be appropriate for plunging cheeses and meats into an olive, a fruit or a vegetable, or any other appropriate food material.

FIG. 6B is a perspective view of plunging head 600 shown in FIG. 6A. Plunging head 600 includes gripping section 122 and axial gap 610 on an end opposite gripping section 122.

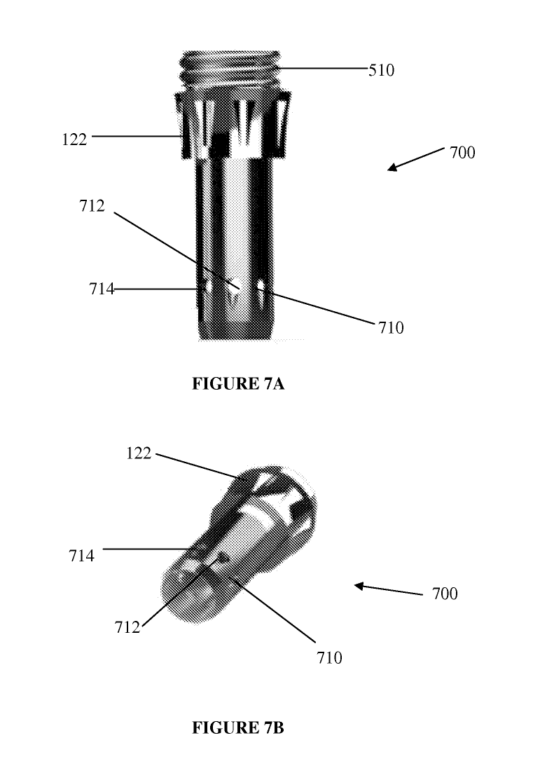

FIG. 7A is an elevation view of a grating head 700 of an exemplary embodiment of the infuser. Grating head 700 includes threads 510 for attachment to the body of an infuser, and gripping section 122 for grasping grating head 700 when attaching or detaching it from the body of an infuser. Grating head 700 also includes grating openings 710, 712, 714 on an end opposite threads 510.

Grating head 700 may have sharp edges, and in particular the bottom edges may be sharp and chamfered. Grating head 700 may have sharp internal grater walls. Grating head 700 may not be designed for the user to directly touch the edges. The top of grating head 700 may be threaded for easy assembly to the body of the product. Grating head 700 may be loaded by plunging the grater head into the desired filling, similar to the plunging head. Grating head 700 may differ from the plunging head since grating head 700 has grating openings 710, 712, 714 (also referred to herein as grater holes or holes). Grating openings 710, 712, 714 allow the user to get more juices and flavors out of his or her desired filling. Grating head 700 may be appropriate for fruit such as apples or strawberries, garlic or zest. Grating head 700 may fill from the exposed head.

FIG. 7B is a perspective view of grating head 700 shown in FIG. 7A. Grating head 700 includes gripping section 122 and grating openings 710, 712, 714 on an end opposite gripping section 122.

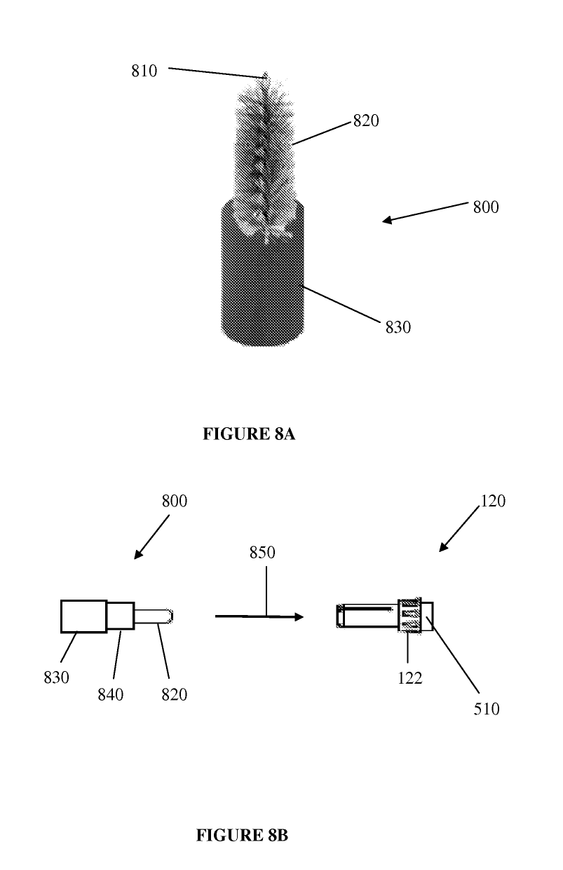

FIG. 8A is a perspective view of brush 800 of an exemplary embodiment of the infuser. Brush 800 includes bristle stem 810 on which bristles 820 are mounted. Bristles stem 810 may be metal, plastic or any other appropriate material, and bristles 820 may be nylon, plastic or any other appropriate material. Brush 800 also includes base 830, which may be silicone, rubber, plastic or any other appropriate material. Bristle stem 810 may be mounted in or on base 830. Brush 800 may be attached to the plunger of an exemplary infuser to create a handle for brush 800 to facilitate using the brush. Base 830 of brush 800 may have an opening opposite bristle stem 810 for insertion of the end of the plunger for user of the plunger as a handle for brush 800.

FIG. 8B is a side schematic view of brush 800 and cutting head 120 of an exemplary embodiment of the infuser. Brush 800 may include bristles 820, base 830, and element 840, which may function to provide a friction fit with an interior surface of a cutting head. Element 840 may be silicone, rubber, plastic or any other appropriate material, and may be integrated with base 830 or a separate element that is attached to base 830 by any appropriate method.

Brush 800 may be housed inside cutting head 120 of an exemplary infuser. Brush 800 may act as a cap for the blade of cutting head 120. Cutting head 120, which may be mounted on an exemplary infuser, may be capped by moving brush 800 in the direction of arrow 850 so that bristles 820 enter the interior of cutting head 120. Element 840 also enters the interior of cutting head 120 to create a tight or snug fit, thereby creating a friction fit with cutting head 120, or any interchangeable head. In this manner, cutting head 120 is capped by brush 800, rendering the sharp bottom edge of cutting head 120 safe due to the coverage provided by base 830.

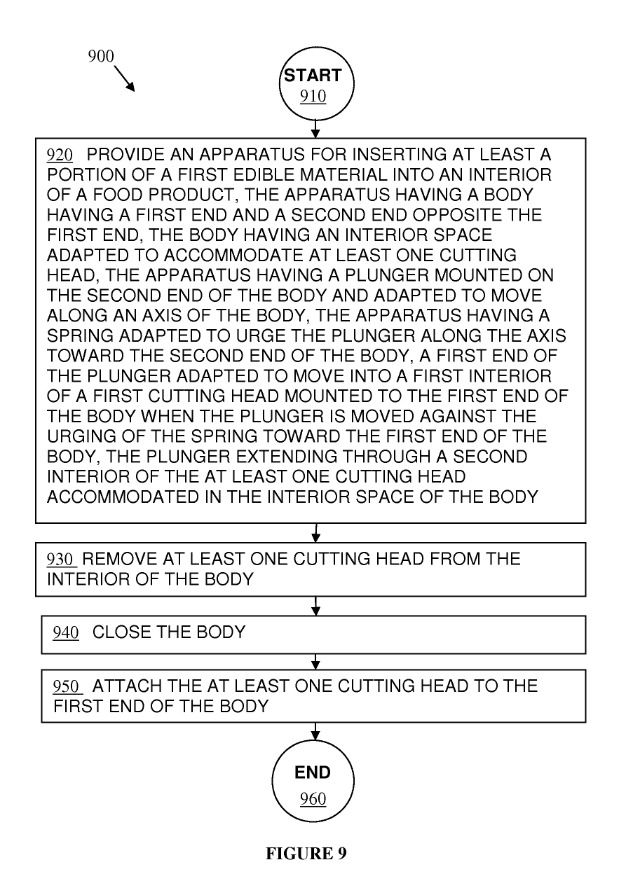

FIG. 9 illustrates method 900 according to an exemplary embodiment in a flow chart. Method 900 starts at start circle 910 and proceeds to operation 920, which indicates to provide an apparatus for inserting at least a portion of a first edible material into an interior of a food product. The apparatus has a body having a first end and a second end opposite the first end. The body has an interior space adapted to accommodate at least one cutting head. The apparatus has a plunger mounted on the second end of the body and adapted to move along an axis of the body. The apparatus has a spring adapted to urge the plunger along the axis toward the second end of the body. A first end of the plunger is adapted to move into a first interior of a first cutting head mounted to the first end of the body when the plunger is moved against the urging of the spring toward the first end of the body. The plunger extends through a second interior of the at least one cutting head accommodated in the interior space of the body. From operation 920, the flow in method 900 proceeds to operation 930, which indicates to remove at least one cutting head from the interior of the body. From operation 930, the flow in method 900 proceeds to operation 940, which indicates to close the body. From operation 940, the flow in method 900 proceeds to operation 950, which indicates to attach the at least one cutting head to the first end of the body. From operation 950, the flow in method 900 proceeds to end circle 960.

Additionally or alternatively, a device having only one head and a single body may be provided. The single body will have no internal storage space for additional heads. The single body will house the spring and the plunger. The spring and the plunger will not be removable. The single head will be threaded, and therefore removable from the body.

While only a limited number of preferred embodiments of the present invention have been disclosed for purposes of illustration, many modifications and variations could be made thereto. The present application is intended to cover all of those modifications and variations which fall within the scope of the present invention, as defined by the following claims.

We claim:

1. A device for inserting at least a portion of a first edible material into an interior of a food product, comprising:
a body having a first end and a second end opposite said first end, said body having an axis;
a plunger associated with said body and adapted to move along said axis;
a spring adapted to urge said plunger along said axis toward said second end; and
at least one hollow cylindrical head adapted to be removably mounted to said first end of said body, wherein a first end of said plunger is adapted to move into an interior of said head mounted to said first end of said body when said plunger is moved against the urging of said spring toward said first end of said body;
wherein said body accommodates at least one head in an interior space accessible by an opening arranged on said body.

2. The device of claim 1, wherein a second end of said plunger extends beyond said second end of said body under an influence of said spring, said second end of said plunger being adapted to be depressed to cause said plunger to move toward said first end of said body.

3. The device of claim 2, further comprising a cleaning brush adapted to removably mount inside said at least one hollow cylindrical head when said at least one hollow cylindrical head is mounted to said first end of said body.

4. The device of claim 3, wherein at least one of:
said cleaning brush is adapted to cap said at least one hollow cylindrical head; and
said cleaning brush is adapted to removably mount to said second end of said plunger.

5. The device of claim 1, further comprising a second hollow cylindrical head, wherein said body is adapted to accommodate at least two heads in said interior space arranged in a stacked configuration.

6. The device of claim 1, wherein said at least one head in said interior space is arranged so that said plunger extends through another interior of said at least one head in said interior space.

7. The device of claim 1, wherein said at least one hollow cylindrical head includes a grating head comprising internally sharp grater walls, said grating head adapted to be loaded by inverting said device and pressing said first edible material in a grated form into said grating head.

8. The device of claim 1, wherein said at least one hollow cylindrical head includes a scooping head comprising an indentation on a cutting end opposite an end of said scooping head attached to said body, said indentation adapted to scoop material into said scooping head.

9. The device of claim 1, wherein said at least one hollow cylindrical head includes a plunging head comprising a blade on a cutting end opposite an end of said plunging head attached to said body.

10. The device of claim 9, wherein said plunging head comprises at least one axial gap extending from said cutting end in an axial direction and having a length less than a length of the head.

11. The device of claim 10, wherein said plunging head comprises at least two axial gaps.

12. The device of claim 11, wherein at least two of said axial gaps have different lengths.

13. The device of claim 1, wherein said first and said second ends of said body have larger cross-sectional areas perpendicular to said axis than a mid-section of said body between said first and said second ends.

14. A device for inserting at least a portion of a first edible material into an interior of a food product, comprising:
a body having a first end and a second end opposite said first end, said body having an axis;
a plunger associated with said body and adapted to move along said axis;
a spring adapted to urge said plunger along said axis toward said second end;
at least one hollow cylindrical head adapted to be removably mounted to said first end of said body, wherein a first end of said plunger is adapted to move into an interior of said head mounted to said first end of said body when said plunger is moved against the urging of said spring toward said first end of said body; and
means for preventing removal of said spring and said plunger.

15. A system for inserting at least a portion of a first material into an interior of a second material, comprising:
a body adapted to be grasped by a hand of a user and having a target end and a user end opposite the target end, the body having an axis extending from the target end to the user end;
a plunger coupled to the body and adapted to move along the axis;
a spring adapted to urge the plunger along the axis in a first direction toward the user end; and
a set of interchangeable, hollow cylindrical heads, each of the heads adapted to removably attach to the body on the axis on the target end, the plunger adapted to move into an interior of one of the heads attached to the body when the plunger is moved against the spring in a second direction opposite the first direction.

16. The system of claim 15, wherein:
the body is adapted to accommodates at least one head in an interior space accessible by an opening arranged on the body; and
the at least one head in the interior space is arranged so that the plunger extends through another interior of the at least one head in the interior space.

17. The system of claim 16, wherein an end of the plunger extending out of the user end of the body is adapted to be depressed to cause the plunger to move along the axis in the second direction.

18. The system of claim 15, further comprising:
a cleaning brush adapted to removably mount inside the head attached to the body when the head is attached to the body;
wherein the cleaning brush is adapted to cap the head when the head is attached to the body; and
wherein the cleaning brush is adapted to removably attach to the end of the plunger.

19. The system of claim 15, wherein the set of interchangeable heads includes:
a grating head having internally sharp grater walls, the grating head adapted to be loaded by inverting the system and pressing the first material in a grated form into the grating head;
a scooping head having an indentation on a lower rim opposite the end attached to the body, the indentation adapted to assist a user in scooping material into the scooping head; and
a plunging head having a blade arranged on a lower rim opposite the end attached to the body, the plunging head including at least two axial gaps extending from the lower rim in an axial direction and having a length less than a length of the head.

20. A method of changing heads of an apparatus for inserting at least a portion of a first edible material into an interior of a food product, the apparatus having a body having a first end and a second end opposite the first end, the body having an interior space adapted to accommodate at least one cutting head, the apparatus having a plunger mounted on the second end of the body and adapted to move along an axis of the body, the apparatus having a spring adapted to urge the plunger along the axis toward the second end of the body, a first end of the plunger adapted to move into a first interior of a first cutting head mounted to the first end of the body when the plunger is moved against the urging of the spring toward the first end of the body, the plunger extending through a second interior of the at least one cutting head accommodated in the interior space of the body, the method comprising:
removing at least one cutting head from the interior of the body;
closing the body; and
attaching the at least one cutting head to the first end of the body.

21. A set of stackable, hollow heads, each of the heads adapted to mount to an end of a device for inserting at least a portion of a first edible material into an interior of a food product, the device having a body with a hollow interior, an axis, and a spring-loaded plunger adapted to move along said axis toward said end of said body, wherein said body interior is adapted to accommodate at least two heads arranged in a stacked configuration so as to permit movement of said plunger through said stacked heads when said stacked heads are received in said body interior.
